(19) United States
(12) Patent Application Publication
(10) Pub. No.: US 2020/0009716 A1
(43) Pub. Date: Jan. 9, 2020

(54) Portable and Collapsible Workhorse

(71) Applicant: James LaSalle, Salt Lake City, UT (US)

(72) Inventor: James LaSalle, Salt Lake City, UT (US)

(21) Appl. No.: 16/026,376

(22) Filed: Jul. 3, 2018

(51) Int. Cl. B25H 1/06

(52) U.S. Cl. CPC B25H 1/06

(57) ABSTRACT

An improved, portable and collapsible workhorse is described and claimed herein. In an expanded/use configuration, the device provides a stable, sturdy, generally horizontal support for supporting other items, such as planar work surfaces, work pieces or other items. The device can easily be reconfigured from the expanded/use configuration to a collapsed/storage configuration, and vice versa, without any tools or assembly required. When in the collapsed/storage configuration, the device provides a flat, compact form factor that is very convenient and efficient for packaging, shipping, transportation and storage.

### BACKGROUND OF THE INVENTION

The invention relates to structures for supporting work pieces and/or work surfaces. More particularly, the intention is directed to an improved, portable and collapsible workhorse.

### BRIEF SUMMARY OF THE INVENTION

An improved, portable and collapsible workhorse is described and claimed herein. In an expanded/use configuration, the device provides a stable, sturdy, generally horizontal support for supporting other items, such as planar work surfaces, work pieces or other items. The device can easily be reconfigured from the expanded/use configuration to a collapsed/storage configuration, and vice versa, without any tools or assembly required. When in the collapsed/storage configuration, the device provides a flat, compact form factor that is very convenient and efficient for packaging, shipping, transportation and storage. The device can be readily manufactured from a variety of materials, depending on the strength and other factors required for a particular application.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 shows a perspective view of one embodiment of the workhorse device.

FIG. 2 shows a second perspective view from a different point of view.

FIG. 3 shows a side view of the device.

FIG. 4 shows an end view of the device.

FIG. 5 shows a detail view of an upper portion of the device.

FIG. 7 shows another detail view of an upper portion of the device, including a view of one embodiment of a pivoting hinge.

FIG. 7 provide yet another detail view, showing one embodiment of a folding/locking hinge.

FIGS. 8A and 8B show front and back views, respectively, of the device in a compact, collapsed/storage configuration.

FIGS. 9A and 9B show details of one embodiment of storage latches that can be incorporated into the device.

### DETAILED DESCRIPTION OF THE PREFERRED EMBODIMENTS

The invention is directed to an improved, portable and collapsible workhorse is described and claimed herein. In an expanded/use configuration, the device provides a stable, sturdy, generally horizontal support for supporting other items, such as planar work surfaces, work pieces or other items. The device can easily be reconfigured from the expanded/use configuration to a collapsed/storage configuration, and vice versa, without any tools or assembly required. When in the collapsed/storage configuration, the device provides a flat, compact form factor that is very convenient and efficient for packaging, shipping, transportation and storage. The device can be readily manufactured from a variety of materials, depending on the strength and other factors required for a particular application.

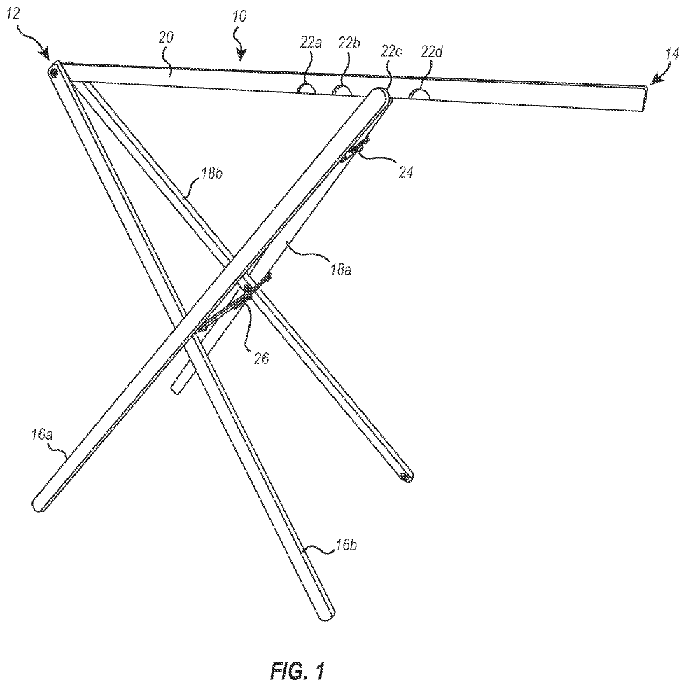

FIG. 1 illustrates a perspective view of one embodiment of the workhorse device 10. In describing device 10, the end generally designated by reference numeral 12 will be referred to as the “proximal” end of the device, and the end generally designated by reference numeral 14 will be referred to as the “distal” end of the device.

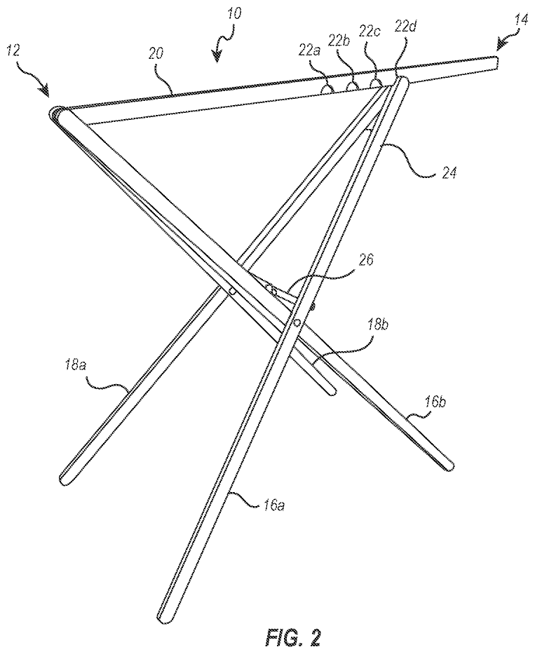

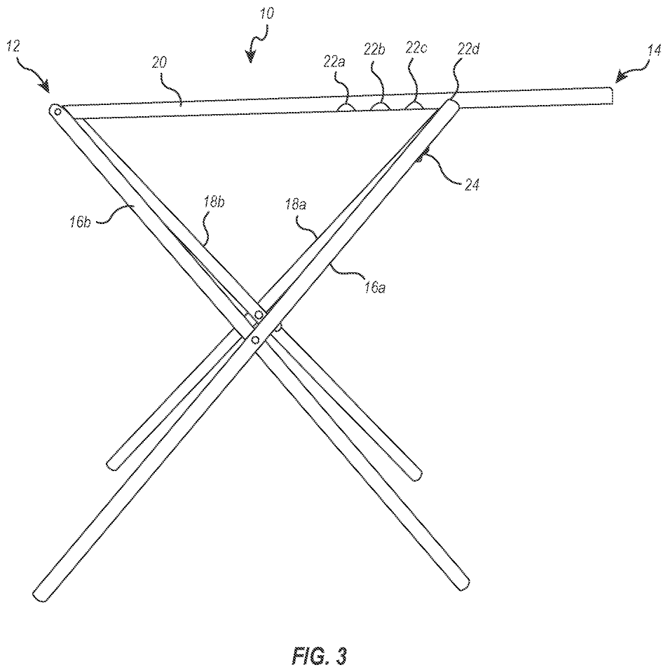

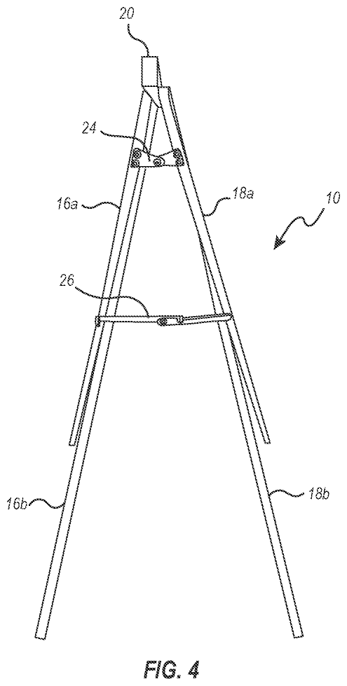

Referring generally to FIGS. 1-4, device 10 can include two pair of support legs 16 and 18. Each support leg pair 16 and 18 can include an outer support leg 16a and 18a, respectively, and an inner support leg 16b and 18b, respectively. Outer support leg 16a and inner support leg 16b can be rotatably connected at or near the middle and, as discussed in more detail below, cooperate with one another to form a first scissor jack. Similarly, outer support leg 18a and inner support leg 18b can be rotatably connected at or near the middle and also cooperate with one another to form a second scissor jack.

Device 10 can also include a top crossbar or support bar 20 that is supported by the two support leg pairs 16 and 18 as discussed in additional detail below. Crossbar 20 can include a plurality of recesses 22 located at an intermediate location and being formed in opposing sides of crossbar 20. In the illustrated embodiment, four sets of recesses 22a-d are provided, but any number of recesses can be selected based on the number of different height settings that are desired. As further described below, recesses 22 are configured to receive the distal or upper ends of outer support legs 16a and 18a when device 10 is placed in its expanded/use configuration. In addition, the planar surface of each of recesses 22 form an angle relative to the adjacent lateral surface of crossbar 20, and that angle can be approximately the same as the angle formed by outer support legs 16a and 18a relative to crossbar 20 when device 10 is positioned and locked into place in its expanded/use configuration. In other words, as can be seen in the Figures, the depth of the upper portions of each recess 22 is greater than the depth of the lower portions.

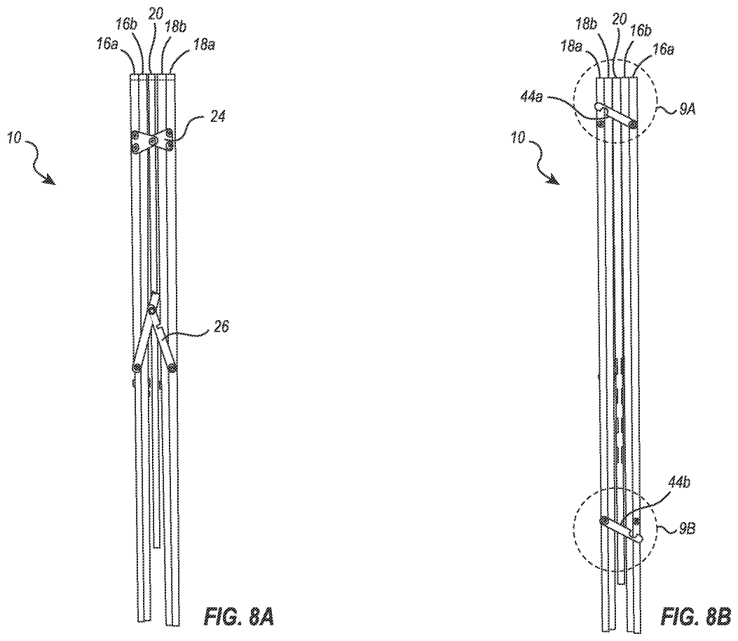

As further shown in the accompanying Figures, the proximal ends of crossbar 20, inner support leg 16b and inner support leg 18b are connected together, with the proximal end of crossbar 20 being interposed between the proximal or upper end of inner support leg 16b and the proximal or upper end of inner support leg 18b. The connection can be made with any suitable fastener that allows (i) rotation of crossbar 20 about the axis of the fastener and relative to inner support legs 16b and 18b and (ii) inner support legs 16b and 18b to move in a transverse direction relative to one another between the expanded/use configuration (in which inner support legs 16b and 18b are splayed out at an angle relative to one another, as shown in FIG. 1) and the collapsed/storage configuration (in which inner support legs 16b and 18b are positioned parallel with one another, as shown in FIGS. 8A and 8B). As further shown in FIGS. 1-4, the distal or lower ends of inner support legs 16b and 18b rest on the floor or other support surface when the device is in use. Similarly, the proximal or lower ends of outer support legs 16a and 18a also rest on the floor or other support surface when in use.

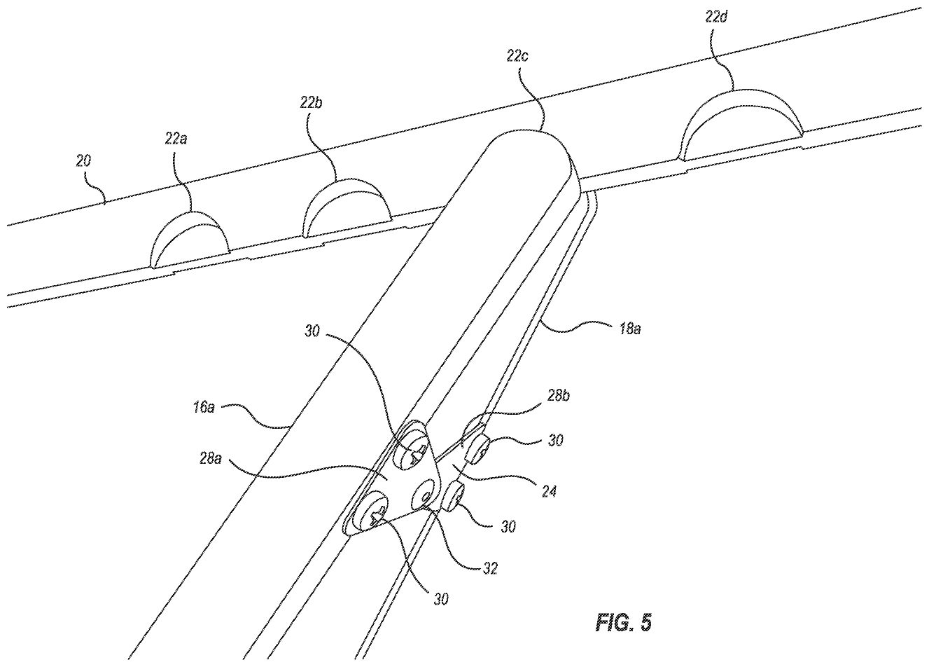

As best seen in FIGS. 5 and 6, the distal or upper ends of outer support legs 16a and 18a can engage one of recesses 22a-d on either side of crossbar 20, and provide a second point of support to, and at an intermediate position along crossbar 20. It should be apparent, due to the scissor jack arrangement formed by support leg pairs 16 and 18, that the overall height of crossbar 20 can be adjusted based on which of recesses 22a-d the distal or upper ends of outer support legs 16a and 18a are placed into. More specifically, recess 22a provides the highest setting for crossbar 20, whereas recess 20d provides the lowest setting for crossbar 20.

As further detailed below, when in the expanded/use configuration outer support legs 16a and 18a cooperate to engage an opposing pair of recesses 22a-d and pinch or clamp crossbar 20 therebetween to form a secure, static connection. In the illustrated embodiment, the upper or distal ends of outer support legs 16a and 18a are rounded to approximate the shape of recesses 22 for complementary engagement between the two elements. Although these shapes are shown as being generally round or circular in the illustrated embodiment, the device can be adapted to accommodate any other suitable shape or configuration.

Device 10 can also include a pivoting bracket 24 forming a first connection between outer support legs 16a and 18a. As best illustrated in FIGS. 5 and 6, pivoting bracket 24 is located toward the distal or upper ends of outer support legs 16a and 18a. Bracket 24 allows outer support legs 16a and 18a to move in a transverse direction relative to one another between the expanded/use configuration (in which outer support legs 16a and 18a are splayed out at an angle relative to one another, as shown in FIG. 1) and the collapsed/storage configuration (in which outer support legs 16b and 18b are positioned parallel with one another, as shown in FIGS. 8A and 8B).

In one exemplary embodiment, pivoting bracket 24 can be fashioned from a pair of triangular steel or aluminum plates 28a and 28b. An outer end of each of plates 28a and 28b can be connected to a lower surface of outer support leg 16a and 16b, respectively, with a screw or other suitable connector 30. The other end of each of plates 28a and 28b can be connected together by means of a pin 32 in such a way that plates 28a and 28b can pivot or rotate relative to one another about pin 32.

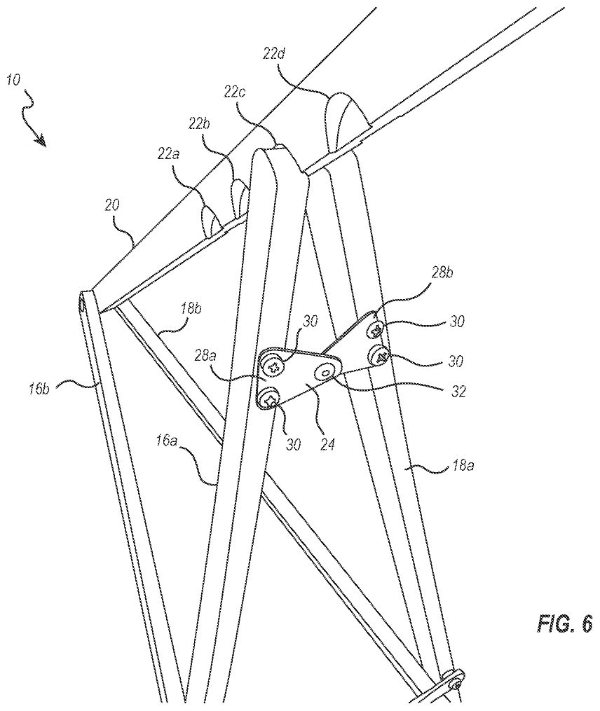

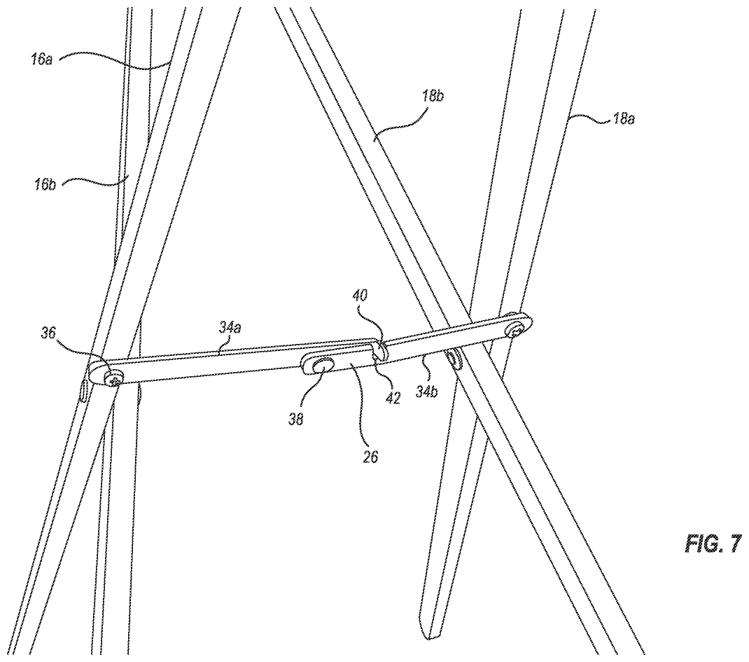

Device 10 can also include a folding/locking bracket 26 forming a second connection between outer support legs 16a and 18a. As best illustrated in FIG. 7, folding bracket 26 is located at or near the middle of outer support legs 16a and 18a. The relative positions and dimensions of pivoting bracket 24 and folding bracket 26 are selected so that, when folding bracket is in an extended and locked position, the distal or upper ends of outer support legs 16a and 18a cooperate to pinch or clamp crossbar 20 therebetween (at a selected one of recess pairs 22a-d) with sufficient force to form a secure, static connection and so that all of the elements of device 10 are securely locked into place relative to one another. For example, when securely locked into place, device 10 can be grasped and lifted by crossbar 20 and all of the elements will remain locked into place and static relative to one another.

In one exemplary embodiment, folding/locking bracket 26 can include a first arm 34a and a second arm 34b. One end of each of arms 34a and 34b are connected to the lower side of outer support legs 16a and 16b, respectively, in such a way that arms 34a and 34b can pivotally rotate relative to legs 16a and 18a. Each of arms 34a and 34b can be connected to outer support legs 16a and 16b with a screw or other suitable fastener 36. The other ends of arms 34a and 34b can be connected to each other by means of a pin 38 in such a way that arms 34a and 34b can pivot or rotate relative to one another about pin 38. Arm 34a can also include a flange 40 at its distal end that extends at a right angle and that can engage a recess 42 formed in a side portion of arm 34b in order to lock arms 34a and 34b into place when device 10 is placed in its expanded/use configuration.

To reconfigure device 10 from its expanded/use configuration to its collapsed/storage configuration, folding bracket 26 is released from its fully extended and locked position and moved to an intermediate position. This allows the lower portions of outer support legs 16a and 18a to rotate toward one another about pivoting bracket 24. This rotational movement, in turn, causes the distal or upper ends of outer support legs 16a and 18a to rotate and move away from recesses 22, thereby unclamping and releasing crossbar 20. Once released, crossbar 20 can then be rotated around the connection at its proximal end so that the distal end of crossbar 20 moves up and away from the distal ends of outer support legs 16a and 18a (with the orientation depicted in FIG. 1, such rotation of crossbar 20 would be in the counterclockwise direction). Then the upper ends of outer support legs 16a and 18a and the upper ends of inner support legs 16b and 18b can be rotated toward one another until they are generally in alignment with one another. Rotation of crossbar 20 can also continue until it comes all the way around and into contact with the bottom surface of locking bracket 26 and into alignment with outer support legs 16a and 18a and inner support legs 16b and 18b. Finally, folding bracket 26 can be further folded or collapsed until crossbar 20, outer support legs 16a and 18a and inner support legs 16b and 18b are all positioned parallel and closely adjacent to one another, as shown in FIGS. 8A and 8B.

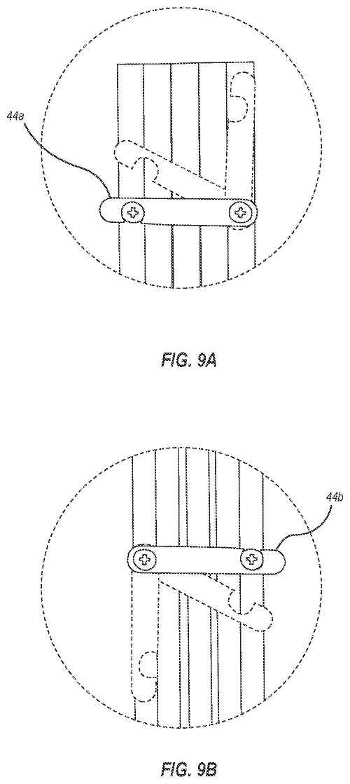

As shown in FIGS. 9A and 9B, device 10 can also include one or more storage latches 44a and 44b. In one exemplary embodiment, and as shown in FIG. 9A, storage latch 44a can be pivotally connected to outer support leg 16a with a screw or other suitable connector, such that storage latch 44a can rotated about the screw or other connector. When device 10 is in its collapsed/storage configuration, storage latch 44a can be selectively rotated until a notch formed in its distal end engages a cooperating pin located on the other outer support leg 18a. Similarly, as shown in FIG. 9B, storage latch 44b can be pivotally connected to outer support leg 18a with a screw or other suitable connector, such that storage latch 44b can rotated about the screw or other connector. When device 10 is in its collapsed/storage configuration, storage latch 44b can also be selectively rotated until a notch formed in its distal end engages a cooperating pin located on the other outer support leg 16a. When engaged, storage latches 44a and 44b securely retain all of the elements of device 10 in its collapsed/storage configuration.

Conversely, to reconfigure device 10 from its collapsed/storage configuration to its expanded/use configuration, the foregoing steps are performed in essentially the opposite order.

The particular size, shape and materials of device 10 can be selected based on the particular application and strength requirements thereof, and the following exemplary embodiment is provided by way of illustration only and is not intended to limit the scope of the invention. In one exemplary embodiment: device 10 can be fabricated of 1″ by ½″ thick aluminum bar stock; each of support legs 16a, 16b, 18a and 18b can be about 39⅞″ in length; crossbar 20 can be about 35-½″ to about 39⅞″ in length. When in the expanded/use configuration, the angle formed between outer support leg 16a and outer support leg 18a can be about 22 degrees, and the angle formed between inner support leg 16b and inner support leg 18b can be about 20 degrees. With the distal ends of outer support legs 16a and 18a positioned within recess 22d, the overall footprint of device 10 can be about 18″ wide and about 27″ long, and the height of crossbar 20 can be about 30½″ tall. With the distal ends of outer support legs 16a and 18a positioned within recess 22a, the overall footprint of device 10 can be about 18″ wide by about 20″ long, and the height of crossbar 20 can be about 35½″ tall. When in the collapsed/storage configuration, the overall dimensions of device 10 can be about 1″ tall, about 3¾″ wide, and about 39⅞″ long. Thus, the ratio between the height of device 10 when in the collapsed/storage configuration and the height of device 10 when in the expanded/use configuration can range from about 1 to 30.5 to about 1 to 35.5. Similarly, the ratio between the width of device 10 the when in the collapsed/storage configuration and the width of device 10 the when in the expanded/use configuration can be about 1 to 21. Further still, the ratio between the volume occupied by device 10 when in the collapsed/storage configuration and the volume occupied by device 10 when in the expanded/use configuration can be from about 1 to 47.33 to about 1 to 63.9.

Once again, the invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An improved workhorse device comprising:
a first support leg pair having a first inner support leg and a first outer support leg, the first inner and outer support legs each having a proximal end, a middle and a distal end, the first inner and outer support legs being rotatably connected to one another at or near the middle of each and forming a first scissor jack, and the distal end of the first inner support leg being adapted to rest on a support surface during use of the device;
a second support leg pair having a second inner support leg and a second outer support leg, the second inner and outer support legs each having a proximal end, a middle and a distal end, the second inner and outer support legs being rotatably connected to one another at or near the middle of each and forming a second scissor jack, the distal end of the second inner support leg being adapted to rest on a support surface during use of the device, and the proximal ends of the first and second outer support legs being adapted to rest on a support surface during use of the device;
a crossbar having a proximal end, a distal end, an intermediate portion between the proximal and distal ends, a top surface providing a flat support surface, and two opposing side surfaces being adjacent to and perpendicular to the top surface, the crossbar being rotatably connected at or near its proximal end with the proximal ends of the first and second inner support legs, the crossbar having one or more recesses formed in the opposing side surfaces of the intermediate portion, the recesses being adapted to receive the distal ends of the first and second outer support legs;
a pivoting bracket connected to the first and second outer support legs adjacent the distal ends of the first and second outer support legs, the pivoting bracket providing movement of the first and second outer support legs in a transverse direction relative to one another between a collapsed/storage configuration, in which the first and second outer support legs are essentially parallel with one another, and an expanded/use configuration in which the first and second outer support legs are splayed out at an angle relative to one another; and
a locking bracket connected to the first and second outer support legs at or near the middle of the first and second outer support legs, the locking bracket selectively applying an outward force to the first and second outer support legs, thereby causing the distal ends of the first and second outer support legs to rotate about the rotating bracket to engage an opposing pair of the one or more recesses and apply a clamping force to the opposing side surfaces of the crossbar and selectively locking the device in the expanded/use configuration.

2. The device of claim 1, wherein the one or more recesses formed in the opposing side surfaces of the intermediate portion comprise four pairs of recesses that are formed on opposite sides of the crossbar, the four sets of recesses being spaced at equal intervals along the intermediate portion of the crossbar.

3. The device of claim 2, wherein the distal ends of the first and second outer support legs can be selectively placed into any one of the four pairs of recesses so as to adjust the overall height of the crossbar.

4. The device of claim 3, wherein the distal ends of the first and second outer support legs are rounded and the recesses have a complementary circular shape.

5. The device of claim 4, wherein the first and second inner support legs and the first and second outer support legs are all equal in length.

6. The device of claim 5, wherein the length of the crossbar is the same as the length of the first and second inner support legs and the first and second outer support legs.

7. The device of claim 5, wherein the length of the crossbar is shorter than the length of the first and second inner support legs and the first and second outer support legs.

8. The device of claim 3, further comprising a first storage latch selectively connected between and adjacent to the proximal ends of the first and second outer support legs when the device is positioned in its collapsed/storage configuration.

9. The device of claim 8, further comprising a second storage latch selectively connected between and adjacent to the distal ends of the first and second outer support legs when the device is positioned in its collapsed/storage configuration.

10. The device of claim 1, wherein the ratio between the height of the device when in the collapsed/storage configuration and the height of the device when in the expanded/use configuration is equal to or greater than about 1 to 30.

11. The device of claim 1, wherein the ratio between the width of the device when in the collapsed/storage configuration and the width of the device when in the expanded/use configuration is equal to or greater than about 1 to 20.

12. The device of claim 1, wherein the ratio between the volume occupied by the device when in the collapsed/storage configuration and the volume occupied by the device when in the expanded/use configuration is equal to or greater than about 1 to 47.
